(19) United States
(12) Patent Application Publication
(10) Pub. No.: US 2022/0237294 A1
(43) Pub. Date: Jul. 28, 2022

(54) METHOD FOR VALIDATING TRUSTWORTHY DATA IN A COMPUTER SYSTEM

(71) Applicant: CAMELOT ITLAB GMBH, Mannheim (DE)

(72) Inventors: Andreas GOEBEL, Forst (DE); Steffen JOSWIG, Laudenbach (DE); Josef PACKOWSKI, Heidelberg (DE)

(21) Appl. No.: 17/716,751

(22) Filed: Apr. 8, 2022

Related U.S. Application Data
(63) Continuation of application No. PCT/EP2020/078320, filed on Oct. 8, 2020.

(30) Foreign Application Priority Data
Oct. 8, 2019 (EP) 19201986.7

(51) Int. Cl. G06F 21/57

(52) U.S. Cl. CPC G06F 21/57; G06F 2221/032

(57) ABSTRACT

A method is provided for validating trustworthy data in a computer system which comprises a distributed repository network, a client system coupled to the repository network and a server system coupled to the repository network. The trustworthy data comprise data sets which are stored in a memory device of the first server system. A validation query message is generated on the client system, which validation query message is stored in the repository network and transferred to the server system. The server system transfers the validation query message for response to a trustworthy software component, which is executed in a trustworthy and secured environment of the server system. The trustworthy software component generates a validation reply message, which is stored in the repository network and transferred to the client system.

### CROSS REFERENCE TO RELATED APPLICATIONS

This application is a continuation of International Application No. PCT/EP2020/078320, filed Oct. 8, 2020, which claims priority to European Patent Application No. 19201986.7, filed Oct. 8, 2019, the contents of each of which are incorporated by reference herein.

### FIELD OF THE INVENTION

Computer-implemented method for validating trustworthy data in a computer system.

### BACKGROUND

In order to be able to validate trustworthy data with a computer-implemented method, it is necessary that the trustworthy data are made available to the computer program which executes the validation. Validation means that the data are checked to see whether they have certain properties. It can happen that the trustworthy data are made accessible to non-authorized persons in an abusive manner, for example due to a manipulation of the computer program or the environment in which the computer program is executed.

A method is known from US 2019/0012666 A1, with which a life cycle of a product can be tracked from production to consumption. Several parties can be involved in the life cycle, each of which can execute a transaction, for example receiving a product or sending a product to another party. All transactions are submitted to a blockchain, verified by the blockchain based on a consensus model, and then stored as new blocks on the blockchain. However, the disadvantage here is that this method is not suitable for validating trustworthy data, since the data to be validated would have to be stored in the blockchain itself and are therefore tamper-proof but no longer trustworthy.

A method is known from WO 2019/185710 A1 in which so-called lightweight blockchain clients can query data from a blockchain. For this purpose, a so-called full node is generated, in which the complete blockchain is initially stored. A first database is then generated in this full node by querying the complete blockchain. A so-called Trusted Execution Environment TEE of the generated full node uses this first database to generate a second database from it, which is assigned exclusively to the TEE. For each query, the TEE accesses the second database and determines the queried data from it, and transfers the queried data in encrypted form to the lightweight blockchain client. The disadvantage here, however, is that this method is not suitable for validating trustworthy data, since only queried data are transferred to a client, but no data are validated.

An object of the present invention is therefore to provide a solution which ensures reliable validation of trustworthy data.

### SUMMARY

Accordingly, a computer-implemented method for validating trustworthy data in a computer system is provided, which comprises:
a distributed repository network,
a first client system which is operatively coupled or operatively couplable to the repository network, and
at least one first server system which is operatively coupled or operatively couplable to this repository network,

wherein the trustworthy data comprise data sets which are stored in a memory device of the first server system, wherein
a first validation query message is generated on the first client system, which first validation query message is stored in the repository network and is transferred to the first server system, wherein the first validation query message comprises information about which data (which are stored in the memory device of the first server system) are to be validated by the first server system,
the first server system receives the first validation query message and transfers it to a trustworthy software component for response, which is executed in a trustworthy and secured environment of the first server system, wherein the trustworthy software component
   reads a number of data sets from the memory device of the first server system based on the first validation query message,
   checks for at least one read data set (which can also be part of an aggregate of read data sets) whether or not this meets predetermined conditions, and
   generates a first validation reply message which comprises information about which of the read data sets meet the predetermined condition, and
the first validation reply message is stored in the repository network and transferred to the first client system.

Embodiments of the method according to the invention have the advantage that trustworthy data can be validated without the trustworthy data themselves having to be disclosed. Executing the trustworthy software component in a trustworthy and secured environment also ensures that the software component cannot be manipulated. A manipulation of the software component can be detected, so that the execution of the manipulated software component can be prevented or suppressed by the trustworthy and secured environment.

The computer system may further comprise a second client system which is operatively coupled or operatively couplable to the repository network, wherein untrustworthy data are transferred from the second client system to the repository network and stored in the repository network.

It is advantageous if the trustworthy software component, when checking whether a read data set meets the predetermined conditions, executes a comparison of the read data set with the untrustworthy data stored in the repository network, wherein it is determined whether data corresponding to the read data set are stored in the repository network, wherein the predetermined conditions are deemed met if data corresponding to the read data set are stored in the repository network.

In one embodiment of the invention, the first client system can monitor the repository network and generate the first validation query message when the untrustworthy data stored in the repository network change.

It is advantageous if the first validation query message and/or the first validation reply message are stored in encrypted form in the repository network.

In one embodiment of the invention, the first server system is coupled or couplable to a second server system, wherein the first server system
generates a second validation query message which is stored in the repository network and is transferred to the second server system based on the first validation query message and/or based on the read data sets, and
receives a second validation reply message from the second server system,

wherein the first server system transfers the received second validation reply message to the first client system as part of the first validation reply message, and

wherein a trustworthy software component which is executed in a trustworthy and secured environment of the second server system,
reads a number of data sets from a memory device of the second server system based on the second validation query message,
checks for at least one read data set whether or not it meets predetermined conditions, and
generates the second validation reply message which comprises information about which of the read data sets meet the predetermined condition.

The trustworthy software component of the second server system can, when checking whether a read data set meets the predetermined conditions, compare the read data set with untrustworthy data stored in the repository network, wherein it is determined whether data corresponding to the read data set are stored in the repository network, wherein the predetermined conditions are met when the data corresponding to the read data set are stored in the repository network.

The second validation query message and/or the second validation reply message can be stored in the repository network in encrypted form.

The first server system can digitally sign the trustworthy software component and store the digital signature in the repository network.

The second server system can digitally sign the trustworthy software component and store the digital signature in the repository network.

The first validation reply message can be digitally signed by the first server system, wherein in the repository network the signature of the first validation reply message is validated using a public key of the first server system, which is stored in the repository network, wherein the validation reply message is transferred to the first client system, if the validation is positive.

The second validation reply message can be digitally signed by the second server system, wherein in the repository network the signature of the second validation reply message is validated using a public key of the second server system, which is stored in the repository network, wherein the second validation reply message is transferred to the first server system, if the validation is positive.

Checking whether a read data set meets the predetermined conditions can be executed using a predetermined validation logic, wherein information about the predetermined validation logic is stored in the repository network.

The distributed repository network can be a blockchain network.

In one embodiment of the invention the trustworthy software component comprises an interpreter adapted to interpret a script and to execute the instructions stored in the script, wherein the instructions comprise validation rules and/or validation instructions.

It can be advantageous here if the script is stored in the distributed repository network, and made available to the interpreter, i.e., the trustworthy software component, for interpretation.

### BRIEF DESCRIPTION OF THE DRAWING

Details and features of the invention will become apparent from the following description in conjunction with the drawing. In the drawing:

FIG. 1 is a block diagram of a computer system for securely executing a workflow;

FIG. 2 is a block diagram, which is used to describe the method for securely executing a workflow in more detail;

FIGS. 3 and 4 are an example of a workflow model;

FIG. 5 is an example process for generating a trustlet;

FIG. 6 is a block diagram, on the basis of which the method for the secured validation of trustworthy data is described in more detail; and

FIG. 7 is a flowchart describing a concrete example of the method for securely validating trustworthy data.

### DETAILED DESCRIPTION OF THE PREFERRED EMBODIMENTS

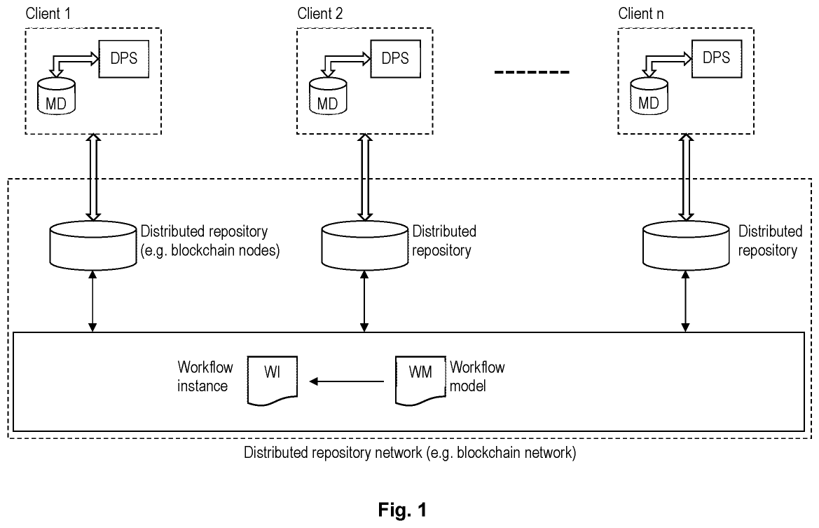

FIG. 1 is a block diagram of a computer system for securely executing a workflow. The computer system comprises a distributed repository network, which is preferably configured as a blockchain network consisting of a number of distributed blockchain nodes. Furthermore, the computer system comprises a number of client systems (client 1, client 2, . . . , client n), which are operatively coupled or operatively couplable to the distributed repository network. The client systems preferably each comprise a data processing system DPS, which in turn each comprises at least one memory device MD (local memory device).

The blockchain nodes can each be assigned to the individual client systems, i.e., the data from these blockchain nodes can each be stored in a memory device of the client systems. Alternatively, the blockchain nodes can also be kept remote from the respective client systems, wherein the client systems are able to access the blockchain nodes via a communication network (e.g., the Internet).

A model of a workflow (also referred to below as a workflow model) is generated on one of the client systems and stored in the distributed repository network. The workflow model is then available for execution by the client systems.

To execute the workflow defined by the workflow model, a workflow instance is generated in the computer system from the workflow model. This workflow instance is then in turn stored in the distributed repository network. Execution conditions and the exact process when executing a workflow or a workflow instance are described in more detail below.

When executing a workflow, i.e., a workflow instance, data can be generated which in turn can be stored in the distributed repository network. Alternatively or additionally, the data generated when executing a workflow instance can also be stored in the local memory devices MD of the client systems.

Furthermore, for executing a workflow instance, data can also be made available, which can also be stored in the distributed repository network and/or in the local memory devices MD of the client systems.

So-called workflow applications are executed on the client systems which are involved in the execution of a workflow instance. A predetermined program code is executed by the workflow application for each workflow step to be executed. The program code can be a so-called chain code or smart contract.

The program code for a workflow step can be stored in the respective client system, for example as part of the respective workflow application. Alternatively, the program code can also be stored in the distributed repository network and be transferred to the respective client system or to the respective workflow application for execution. In one embodiment of the invention, the program code can also be executed on a blockchain node.

A workflow step can comprise multiple actions. In this case, the program code of the workflow step can comprise multiple program code sections, wherein each action of the workflow step is assigned a program code section.

A workflow instance can comprise several workflow steps, wherein each workflow step can be executed on a different client system or by a different workflow application.

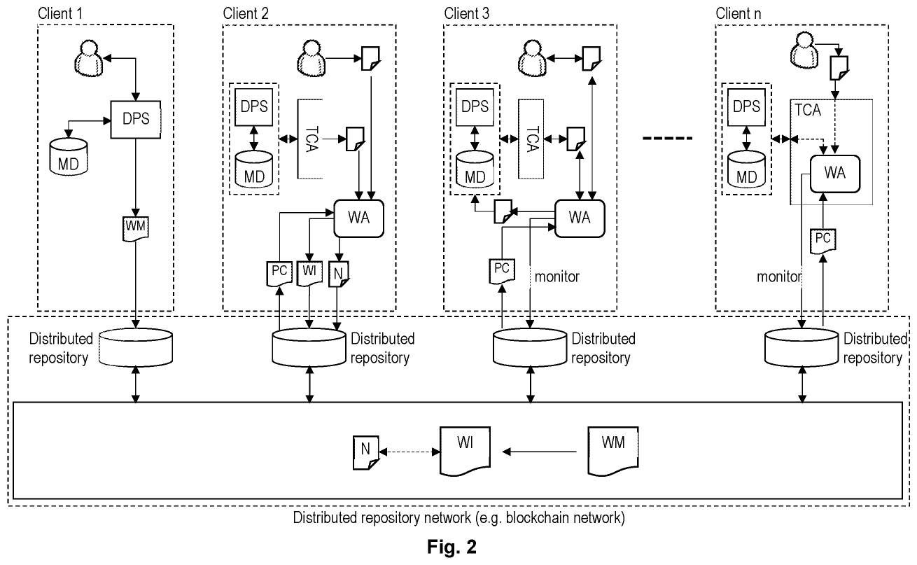

FIG. 2 is a block diagram, which is used to describe the method for securely executing a workflow in more detail.

In the example shown in FIG. 2, four people are involved in the modeling or in the execution of a workflow, wherein each person is assigned to a client system.

In principle, the entire process can be divided into 3 main steps:
Main step 1: generating the workflow model;
Main step 2: generating a workflow instance, i.e., starting a workflow based on a workflow model; and
Main step 3: executing the workflow instance.

### Main Step 1: Generating the Workflow Model

In the example shown in FIG. 2, the main step 1, i.e., generating a workflow model, is executed on the first client system (client 1). For this purpose, software for modeling workflows can be executed on the data processing device DPS of the first client system, with which the desired workflow model can be generated.

A process which is described with a workflow model usually consists of several process steps, wherein several participants can be involved in the process.

A workflow model describes a number of workflow steps, wherein a process step in the workflow model can be represented by a number of workflow steps. In the simplest case, a process step is represented by a workflow step. In addition, a workflow model describes interactions with users (participants involved in the process) and what data are required for the execution of the workflow and what data are generated when the workflow is executed.

The generated workflow model is stored in the distributed repository network, preferably a blockchain network.

According to embodiments of the invention, at least the following is stored or defined in the workflow model for each workflow step:

Execution conditions which must be met to execute the respective workflow step in the computer system. For example, these can be authorizations which a user must have in order to execute the workflow step. Another execution condition could define, for example, which previous workflow steps must be completed successfully in order to be able to execute the workflow step. Yet another execution condition could define, for example, which data must be present in the distributed repository network and/or in the local memory device of the client system on which the workflow step is to be executed in order to be able to execute the workflow step.

The execution conditions for executing the workflow or the workflow instance itself are defined by the execution conditions of the initial step (workflow step which is executed as the first step when the workflow instance is started) of the workflow instance.

Events recorded in the computer system when the workflow step is executed. Events can be, for example, a change in the status of the executed workflow instance or the generation of data by the workflow instance. It is advantageous if the events generated when the workflow instance is executed are stored in the distributed repository network. The events stored in the distributed repository network can then be used as an immutable audit trail for the respective workflow instance.

Tasks assigned to a user, user role, or client system when a workflow step is executed on the computer system. As soon as a task has been executed when a workflow instance is executed, the next workflow step or, if available, the next action within the workflow step is triggered.
a) A task can comprise a workflow step to be executed.
b) Alternatively, a task may comprise an action which must be executed by a user external to the computer system and which must be confirmed to be executed in the computer system. The acknowledgment can be digitally signed and stored in the distributed repository network.
c) In yet another alternative, a task may comprise an action to be executed (without user interaction) by a client system, for example. For example, a task may consist of the client system executing a function in an external computer system. After successful execution, the client system can confirm the execution, wherein the confirmation is preferably digitally signed and stored in the distributed repository network.

Notifications provided to a user, user role, or client system when a workflow step has been successfully executed on the computer system or when a workflow step needs to be executed on the computer system. When a workflow instance is executed, the notifications are stored in the distributed repository network.

It is advantageous if the notifications are stored in encrypted form in the distributed repository network, advantageously using the public key of the instance (user, user role or client system) for which the notification is intended. The public keys required for this can also be stored in the distributed repository network.

The workflow applications, which are executed on the client systems, can monitor the distributed repository network for new notifications. For example, after a workflow step of a workflow instance has been successfully executed on a first client system, a notification for a second client system can be generated and stored in the distributed repository network. With this notification, the second client system can be informed, for example, that the next workflow step can now be executed. Once the second client system “recognizes” this notification, it can proceed to the next workflow step.

Instead of monitoring the distributed repository network for newer notifications, the generated notifications can also be sent directly to the appropriate recipients by the distributed repository network, for example as an e-mail. The notifications can also be stored in the distributed repository network in this case.

Furthermore, information on a number of actions can be defined and stored in the workflow model for each workflow step, which can be executed when the workflow step of a workflow instance is executed.

In a further embodiment of the invention, provision can be made for storing so-called rollback information or rollback actions in the workflow model, with which actions and/or workflow steps already executed when a workflow instance is executed can be reversed.

In one embodiment of the invention, it is provided that the software for modeling workflows and/or the distributed repository network validate a generated workflow model, so that a workflow instance can only be generated if the workflow model became successfully validated. For example, it can be validated whether all execution conditions specified in the workflow model are valid.

A workflow model can be stored in multiple versions in the distributed repository network. It is advantageous here if a workflow instance can only be generated for the most current version of the workflow model. If a workflow instance is in execution which was started before a new version of the workflow model was stored in the distributed repository network, then this workflow instance will continue to be executed according to the older version's workflow model.

In the workflow model, a predetermined workflow step can be defined as an initial step. The initial step of a workflow is the step which is executed as the first workflow step when a workflow instance is started or executed. Alternatively, the first workflow step in the workflow model is the initial step.

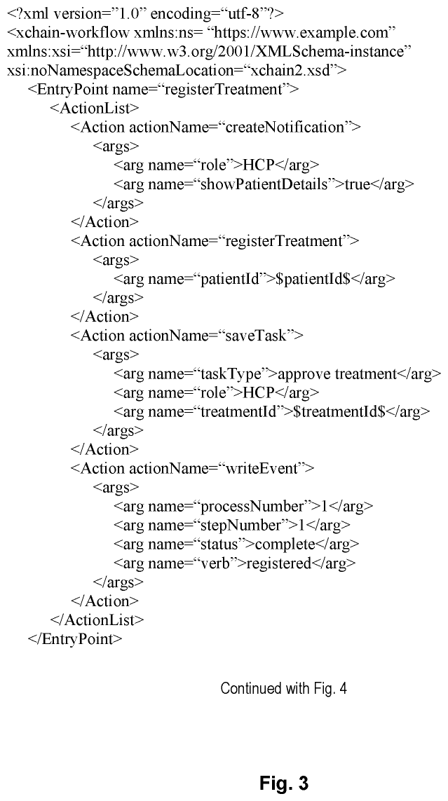

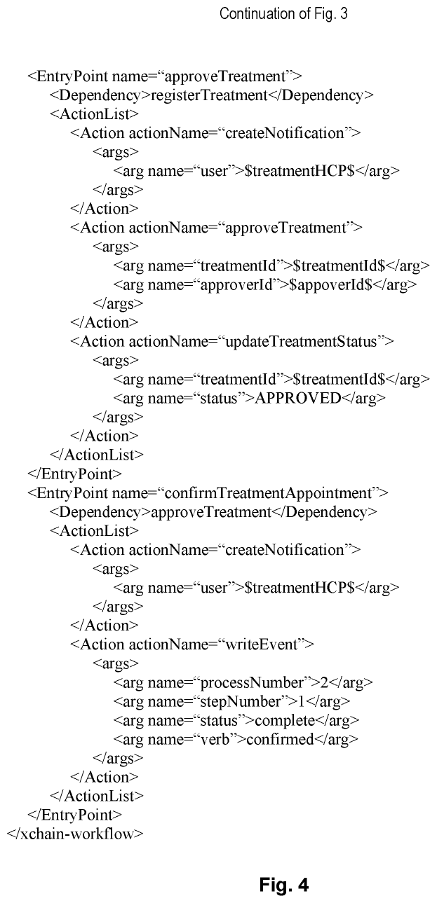

In one embodiment of the invention, the workflow model can be generated as an XML file and stored in the distributed repository network. An example of a workflow model in XML notation is shown in FIGS. 3 and 4.

The nodes <EntryPoint> represent the workflow steps.

The <Dependency> node below the <EntryPoint> node represents execution conditions which must be met before the respective workflow step can be executed so that the workflow step can be executed. For example, the <Dependency>registerTreatment</Dependency> node of the “approveTreatment” workflow step (<EntryPoint name=“approveTreatment”>) indicates that the “registerTreatment” workflow step (<EntryPoint name=“registerTreatment”>) must be completed successfully before the “approveTreatment” workflow step can be executed.

The <Action> nodes below the <ActionList> node represent the actions which are executed or are to be executed when executing the workflow step of a workflow instance. With the <arg> nodes a number of arguments for the respective action can be defined. Values of arguments which are set between two $ (e.g., $patientId$) represent dynamic values which are set during execution of the workflow instance (e.g., by the workflow application). Such dynamic values can be stored in the distributed repository network and read from the distributed repository network during the execution of the respective workflow step and can be made available to the client system or the workflow application which executes the workflow step. Alternatively, such dynamic values can also be stored in the local memory device of the client system executing the workflow step, wherein the respective workflow application is able to read the corresponding value from the local memory device in order to execute the workflow step.

Marked actions are <Action actionName=“createNotification”>, <Action actionName=“saveTask”> and <Action actionName=“writeEvent”>.

With the “createNotification” action a notification is generated and stored in the distributed repository network, wherein the “user” argument specifies the user or the “role” argument specifies the user role for which the notification is intended.

With the “saveTask” action tasks are generated which are assigned to a user or a user role, wherein the “user” argument indicates the user or the “role” argument indicates the user role for which the task is intended.

With the “writeEvent” action events occurring in the computer system when executing the workflow step are stored in the distributed repository network. The action

```
<Action actionName= “writeEvent”>
  <args>
    <arg name=“processNumber”>2</arg>
    <arg name=“stepNumber”>1</arg>
    <arg name=“status”>complete</arg>
    <arg name=“verb”>confirmed</arg>
  </args>
</Action>
```

indicates, for example, that the action specified by “<arg name=“stepNumber”>1</arg>” of the workflow step specified by “<arg name=“processNumber”>2</arg>” is completed and confirmed. In the case of a distributed repository network designed as a blockchain, the current status of a workflow instance can be stored while all previously stored statuses remain unchangeable.

Ultimately, with the “writeEvent” action the status of the executed workflow instance can be stored in the distributed repository network. If several statuses are stored for a workflow instance in the distributed repository network, then the last stored status indicates the current status of the workflow instance.

The workflow model shown in FIGS. 3 and 4 describes a simple workflow for treating a patient. It comprises three workflow steps: “registerTreatment,” “approveTreatment” and “confirmTreatmentAppointment.”

The “registerTreatment” workflow step is the initial step which is executed when the workflow instance is generated.

The “registerTreatment” workflow step is used to initialize the treatment and comprises four actions:

“createNotification”—this is used to create a notification generated for the “HCP” user role wherein the notification contains details about the patient. The “createNotification” action is the first action which is executed when the initial step is executed. This means that when a workflow instance is generated, a notification for the “HCP” user role is first generated and stored in the distributed repository network.

“registerTreatment”—this generates a treatment data set and stores it in the local memory device or in the distributed repository network. The treatment data set is preferably stored in encrypted form. Alternatively, an encrypted hash value of the treatment data set may be stored in the distributed repository network, while the treatment data set itself is stored in the local memory device of the client system where the treatment data set is generated. Furthermore, the treatment data set is assigned to a patient data set, wherein only a unique identifier of the patient data set is stored in the distributed repository network and is assigned to the treatment data set.

“saveTask”—generates a task and assigns it to a user or a user role for completion. In the example shown in FIG. 3, the task “approveTreatment” is generated and assigned to the “HCP” user role. An identifier for the treatment or the treatment data set (treatmentId) is transferred to this action as a further argument.

“writeEvent”—this generates an event, with which the execution of the workflow tep is logged. Based on the generated events, the workflow applications can for example check whether a certain workflow step has been completed correctly before another workflow step is executed.

The “registerTreatment” workflow step is followed by the workflow steps “approveTreatment” and “confirmTreatmentAppointment.” Each of these two workflow steps also has a <Dependency> node which indicates which workflow step the respective workflow step depends on. For example, the “approveTreatment” workflow step depends on the “registerTreatment” workflow step, i.e., the “registerTreatment” workflow step must have been fully and correctly executed before the “approveTreatment” workflow step can be executed. These conditions can be checked by the respective workflow application.

The other nodes of the two workflow steps “approveTreatment” and “confirmTreatmentAppointment” correspond—adjusted accordingly—to the corresponding nodes of the “registerTreatment” workflow steps.

As described above, the workflow model WM generated on the client system 1 or the corresponding XML file is stored in the distributed repository network. The workflow model is then available for execution, possibly after validation, i.e., workflow instances of the workflow model can be generated and executed.

### Main Step 2: Generation of a Workflow Instance

The Main step 2, i.e., the generation of a workflow instance based on the previously generated workflow model, is executed on the second client system (client 2) in the example shown in FIG. 2. For this purpose, a workflow application WA is provided on the second client system, which generates a workflow instance WI of the workflow model WM stored in the distributed repository network upon request by the user of the second client system and stores the generated workflow instance in the distributed repository network.

The workflow instance is generated by executing the initial step defined in the workflow model. The initial step can be the first workflow step in the workflow model. The initial step is executed by the workflow application.

To execute the initial step, the execution conditions stored for this workflow step in the workflow model must be met. For example, the user or user role which wants to execute the initial step and thus generate the workflow instance must have the appropriate authorizations. The workflow application can check the corresponding execution conditions, in particular the authorizations.

When the workflow instance is generated, an image of the workflow model is generated and stored in the distributed repository network. The image of the workflow model can be a JSON document, for example, in which only the name and, if applicable, the version of the workflow model, the names of the workflow steps, the names of the actions and the statuses of the workflow steps are stored. The workflow instances can be stored in a much more compact way than the associated workflow model. The more compact (i.e., more space-saving) memory of the workflow instance is particularly important because any number of workflow instances can be generated for a workflow model, all of which must be stored in the distributed repository network. The status of a workflow instance last stored indicates where the workflow instance is currently located during execution.

When executing or for executing the initial step, the workflow application WA of the second client system (client 2) generates a notification N and stores it in the distributed repository network. Generating notification N is the first action to be taken in the initial step. In the example shown in FIG. 3, the action “createNotification” of the “registerTreatment” workflow step is the first action to be executed.

The notification is assigned to the workflow instance and possibly to a workflow step in the distributed repository network. The notification also specifies for which user or for which user role the notification was generated. In the example given, the notification is intended for the “HCP” user role.

To generate the notification N, the workflow application WA uses a program code PC, which is stored in the distributed repository network and is assigned to the “createNotification” action. The workflow application reads this program code from the distributed repository network and executes it on the client system (client 2). Alternatively, the program code PC can also be stored in the local memory device MD of the client system and can be read from there for execution. In yet another alternative, the PC can also be part of the workflow application WA.

Then, the status of the workflow instance is stored in the distributed repository network. In the present example, after the first action has been executed, the status comprises data concerning the circumstance that the workflow instance is now in the first workflow step and that the second action within the first workflow step is to be executed next.

This completes the generation of the workflow instance.

### Main Step 3: Executing the Workflow Instance.

After the workflow instance has been successfully generated (i.e., after the initial step has been executed), the other workflow steps defined in the workflow model associated with the workflow instance or the other actions provided for in the initial step can be executed.

The further workflow steps or the further actions provided in the initial step can be executed by different client systems or by workflow applications of different client systems. According to the example shown in FIG. 2, these further workflow steps or the further actions provided in the initial step are executed by the client systems client 3 to client n. However, it is also possible according to embodiments of the invention that further workflow steps or further actions of the initial step are executed by the first client system (client 1) on which the workflow model was generated and/or by the second client system (client 2) on which the workflow instance was generated. Where which workflow steps are specifically executed or brought to execution depends primarily on which users or which client systems the respective workflow steps are assigned to.

In the example shown in FIG. 3/FIG. 4, the workflow step “approveTreatment” is assigned to the “HCP” user role, as defined in the

```
<Action actionName=“saveTask”>
  <args>
    <arg name=“taskType”>approve treatment</arg>
    <arg name=“role”>HCP</arg>
    <arg name=“treatmentId”>$treatmentId$</arg>
  </args>
</Action> node
```

of the workflow model.

If only the user of the third client system (client 3) is assigned the “HCP” user role, then the workflow step “approve treatment” can only be executed on the third client system or by the workflow application of the third client system (because the workflow application of the third client system executes the corresponding check of the execution conditions).

According to the example of a workflow model shown in FIG. 3/FIG. 4, the next action to be executed after the generation of the workflow instance is the “registerTreatment” action, as defined in the

```
<Action actionName=“registerTreatment”>
  <args>
    <arg name=“patientId”>$patientId$</arg>
  </args>
</Action> node
```

of the workflow model.

For the following description it is assumed that the further workflow steps or the further actions provided in the initial step are executed by or on the client systems client 3 and/or client n or by the workflow applications of these client systems.

Furthermore, it is assumed for the following description that the first workflow step “registerTreatment” (<EntryPoint name=“registerTreatment”>) has already been executed completely and successfully.

With the “saveTask” action of the first workflow step “registerTreatment” a task was generated and assigned to the “HCP” user role for completion. In this example, the task is to execute the “approveTreatment” workflow step.

With the “writeEvent” action of the first workflow step “registerTreatment” the current status of the workflow instance was stored in the distributed repository network.

After completion of the first workflow step “registerTreatment” the first action (createNotification) of the second workflow step is executed. The “createNotification” action generates a notification N for the user specified in the “user” argument. This notifies the user that the “approveTreatment” workflow step can now be executed.

The generated notification can be transferred from the client system on which the notification was generated directly to a specific client system or to the specified user, for example in the form of an e-mail.

Alternatively, the generated notification can be stored in the distributed repository network and the distributed repository network can transfer the notification to a specific client system or to the specified user.

In yet another alternative, the notification can be stored in the distributed repository network and the client systems or the workflow applications WA executed on the client systems can monitor the distributed repository network for notifications. For this purpose, the workflow applications can query the distributed repository network for existing notifications at regular intervals. It can be advantageous here if a workflow application only queries notifications which are intended for the respective client system or for the user of the client system.

Irrespective of the way in which the notification is transferred, it can be advantageous to encrypt the notification and, if the notification is stored in the distributed repository network, to store the notification in encrypted form.

After the client system has received a notification or if there is a notification for the client system in the distributed repository network, the client system or the respective workflow application can execute the corresponding workflow. In the example shown here, the “treatmentHCP” user receives the notification that the “approveTreatment” workflow step can now be executed.

The “approveTreatment” workflow step can then be executed by the workflow application of the corresponding client system. The first action of the “approveTreatment” workflow step to be executed by the client system is the “approveTreatment” action (<Action name=“approveTreatment”>), i.e., the first action after the “CreateNotification” action.

In order to execute the “approveTreatment” action, the workflow application can execute a program code which is assigned to the “approveTreatment” action. The corresponding program code PC can be stored as a smart contract or as a chain code in the distributed repository network and can be transferred to the corresponding client system for execution. Alternatively, the corresponding program code can also be stored in the memory device MD of the respective client system.

Before or during the execution of the program code assigned to the “approveTreatment” action, it can be provided that it has to be checked whether or not the conditions for executing the action are met.

One of the conditions is defined in the workflow model, namely by the “<Dependency>registerTreatment</Dependency>” node. This node indicates that the “approveTreatment” workflow step cannot be executed until the “registerTreatment” workflow step has been successfully completed. The workflow application can use the status of the workflow instance to determine whether the workflow step “registerTreatment” has been successfully completed. For example, as the last action of the “registerTreatment” workflow step, the “writeEvent” action is executed, which stores the successful completion of the “registerTreatment” workflow step as a status in the distributed repository network. If this status is present in the distributed repository network, then the condition of the “<Dependency>registerTreatment</Dependency>” node can be positively validated by the workflow application and this execution condition is met.

Another condition which must be met for the execution of the “approveTreatment” workflow step can be the corresponding authorization of the executing user. According to the example shown in FIG. 3/FIG. 4, the “approveTreatment” task for the “HCP” user role was generated in the first “registerTreatment” workflow step with the “saveTask” action. This means that the “approveTreatment” workflow step can only be executed by a user assigned the “HCP” role. This assignment can be checked by the workflow application.

In one embodiment of the invention, it may be necessary for the workflow application to require additional data for executing the program code. Such data can be stored in the memory device MD of the client system or in the distributed repository network. Alternatively or additionally, such data can also be provided by the user. If such data are stored in the distributed repository network, it can be advantageous if these data are cryptographically encrypted or at least signed. The encryption of the data represents an implicit condition for the execution of the respective workflow step—because if the data cannot be decrypted, the workflow step cannot be executed successfully either. This means that only those instances (user, role, workflow application) which have the appropriate key for decrypting the data can successfully execute the relevant workflow step.

Furthermore, it can be provided that the workflow application which executes the program code generates data which must then be stored. These data can be stored in the local memory device MD of the respective client system or in the distributed repository network. If the data are stored in the distributed repository network, it can be advantageous if these data are stored in encrypted form, for example using a public key of that instance (user, role, workflow application) which then must be able to read the data.

Alternatively, instead of the data themselves, hash values of the data can also be stored in the distributed repository network, for example when the data themselves are not required. For example, it is sufficient if a first workflow step calculates a hash value for patient data and stores it in the distributed repository network so that a second workflow step can assign treatment data in the distributed repository network to the patient data. In the distributed repository network the treatment data are then assigned to the hash value. The patient data themselves can thus only be stored in a specific client system and thus remain protected.

A so-called Trusted Computing Appliance TCA can be provided for the workflow application to access the data stored in the client system or for storing data in the client system. A Trusted Computing Appliance TCA is a trustworthy and specially secured environment of the client system in which one or more trustworthy software components are executed. The exchange of data between the workflow application and the memory device of the client system can be handled via the Trusted Computing Appliance TCA or via the trustworthy software components of the Trusted Computing Appliance TCA.

The source code of the trustworthy software component, also referred to below as a trustlet, is preferably verified by all those involved in the system.

In order for the workflow application to query data which are stored in the client system, the trustlet can receive a corresponding query from the workflow application. The trustlet then executes the query and transfers the queried data to the workflow application.

It can be advantageous here if the trustlet signs the read data using a private key assigned to the trustlet and makes the signed data available to the workflow application. The workflow application can then validate the signature of the data using the trustlet's public key and only process the data further if the validation is successful.

If the signed data transferred to the workflow application are stored in the distributed repository network, for example because they are required in a subsequent workflow step, it is advantageous if the data are stored in signed form in the distributed repository network. The trustlet's public key is also stored in the distributed repository network. This means that workflow applications being executed on another client system can also validate the signature of the data using the public key of the signing trustlet.

In one embodiment of the invention, each trustlet can be assigned the same cryptographic key pair, so that only one public key needs to be stored in the distributed repository network. In a further embodiment of the invention, however, it is possible for each trustlet or at least some trustlets to be assigned different cryptographic key pairs, wherein the respective public keys are stored in the distributed repository network.

In a further embodiment of the invention, the Trusted Computing Appliance TCA can have a memory device (a so-called private memory device of the TCA), which is therefore also present in a trustworthy and specially secured environment of the client system. It is advantageous here if only the trustlet can access this private memory device of the TCA. In this embodiment of the invention, the trustlet can read data from the private memory device MD of the TCA in addition to data from the memory device MD of the client system. It is advantageous here if the data read of the private memory device of the TCA are not transferred to the workflow application. A check can be executed for the data read of the private memory device of the TCA as to whether they meet predetermined conditions. The result of this check can be transferred to the workflow application without having to transfer the data to the workflow application itself. The result of this check can be digitally signed before being transferred to the workflow application.

Conversely, the trustlet can also store data which the trustlet receives from the workflow application or reads from the private memory device of the TCA in the memory device MD of the client system or transfer it to the data processing system DPS of the client system. In this case, too, the data can be digitally signed by the trustlet, and the signature of the data can be validated, for example by the data processing system DPS of the client system before being stored in the memory device MD of the client system.

In a further embodiment of the invention, the workflow application itself can be a trustlet executed in the Trusted Computing Appliance TCA (see client n in FIG. 2). In this case, the program code which is required to execute the workflow steps can be part of the trustlet. Alternatively or additionally, the program code can also be stored in the distributed repository network. The program code stored in the distributed repository network, like the trustlet itself, is verified by all participants in the system and stored in the distributed repository network with a digital signature. The workflow application designed as a trustlet can then read the program code required for executing a workflow step from the distributed repository network and execute it in the trustworthy computing appliance TCA. The workflow application can check whether the signature of the program code is valid before the program code is executed.

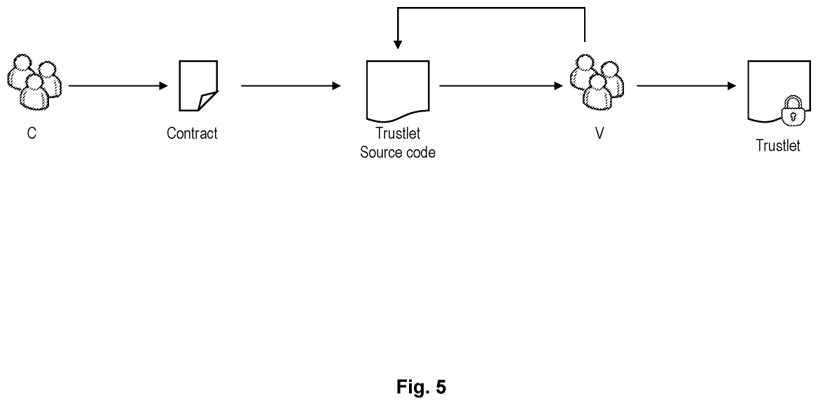

FIG. 5 is an exemplary sequence for generating a trustworthy software component (trustlet).

A group of proprietors or owners C of trustworthy data agree on a reference document, such as a contract, in which the essential points, so-called checkpoints, for validating trustworthy data are specified.

The source code of the trustlet is generated based on this reference document or on the checkpoints contained in the reference document.

The source code of the trustlet is then checked or verified by one or more people V. Should errors, discrepancies or deviations from the checkpoints contained in the reference document arise, the source code of the trustlet will be adjusted and then checked or verified again. This process is executed until the source code of the trustlet no longer shows any deviations from the checkpoints contained in the reference document and the source code of the trustlet is therefore considered verified. The trustlet is then generated from the source code of the trustlet, for example in the form of an executable program.

At this point, the trustlet can be digitally signed. In an alternative embodiment of the invention, the trustlet can then be digitally signed when it is installed on a server system in a trustworthy and secured environment of the server system. In the alternative case, the digital signature for the trustlet can be generated using a private key assigned to the server system. If each server system has different private keys, different digital signatures can be generated by the server and the trustlet, even if one and the same trustlet is installed on several server systems.

According to embodiments of the invention, the digital signature is stored in a distributed repository network, for example in a blockchain network. The trustlet installed on the server system can thus generate data, sign the data generated using its private key and transfer the signed data to a client system, for example. The client system can then use the server system's public key stored in the distributed repository network to check the signature of the data and only process the data further, for example, if the signature check is successful.

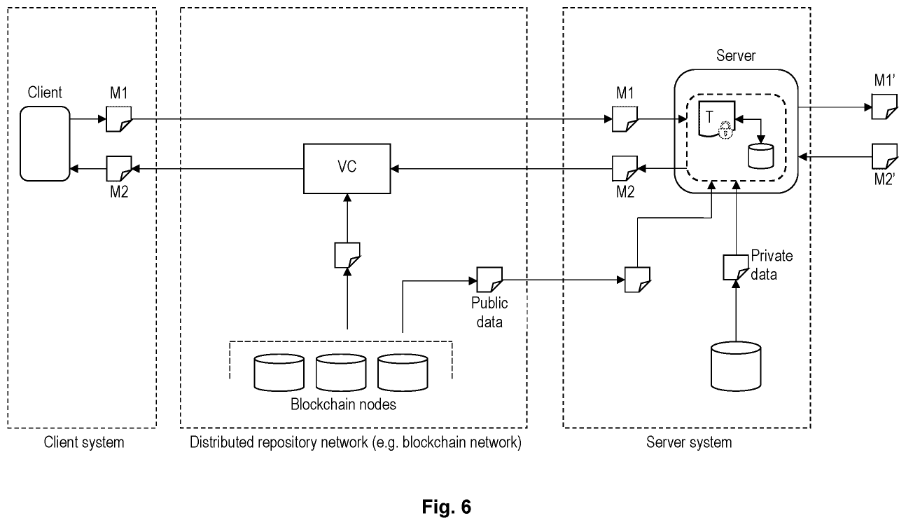

FIG. 6 is a block diagram which is used to describe the method for securely validating trustworthy data in more detail.

FIG. 6 is a client system, a distributed repository network operatively coupled to the client system, and a server system coupled to the distributed repository network. The distributed repository network is preferably a blockchain network which can be formed from a number of distributed blockchain nodes.

The server system essentially comprises a server which provides a trustworthy and secured environment (Trusted Execution Environment). The Trustlet T is installed in this trustworthy and secured environment of the server. The Trustlet T is exclusively executed in this trustworthy and secured environment.

In one embodiment of the invention, a memory device can be present in the trustworthy and secured environment, which memory device is operatively coupled to the trustlet. Preferably only the trustlet has read and write access to this memory device. However, the trustlet can also access a memory device MD of the server system which is outside the trustworthy and secured environment, wherein only read access is shown in FIG. 6.

When installing the trustlet in the trustworthy and secured environment of the server, the trustlet is digitally signed or a digital signature of the trustlet is generated. The trustlet's digital signature is then stored in the distributed repository network.

A first validation query message M1 is generated on the client of the client system, which is stored in the distributed repository network and is transferred to the server of the server system. In this case, the first validation query message M1 comprises information about which data are to be validated by the server of the server system or which data are to be queried from the server. For example, the first validation query message M1 can be used to query the server of the server system as to whether specific data are stored in the server system, either in the memory device provided in a secured and trustworthy environment or in the memory device MD of the server system.

The server of the server system accepts the first validation query message M1 and transfers it to the trustlet T which is executed in the trustworthy and secured environment.

Based on the first validation query message, the trustlet T reads a number of data sets from the memory device MD and/or from the memory device present in the trustworthy and secured environment. After the data sets have been read, the trustlet T generates a first validation reply message M2 and inserts the read data sets into this response message.

In one embodiment of the invention, it can be provided that the trustlet checks whether at least one read data set meets predetermined conditions. The at least one read data set can also be or comprise an aggregate of data sets. In this case, the trustlet can insert information into the validation reply message about which of the read data sets or the aggregate of data sets meet the predetermined condition, without having to insert the data sets themselves into the validation reply message M2.

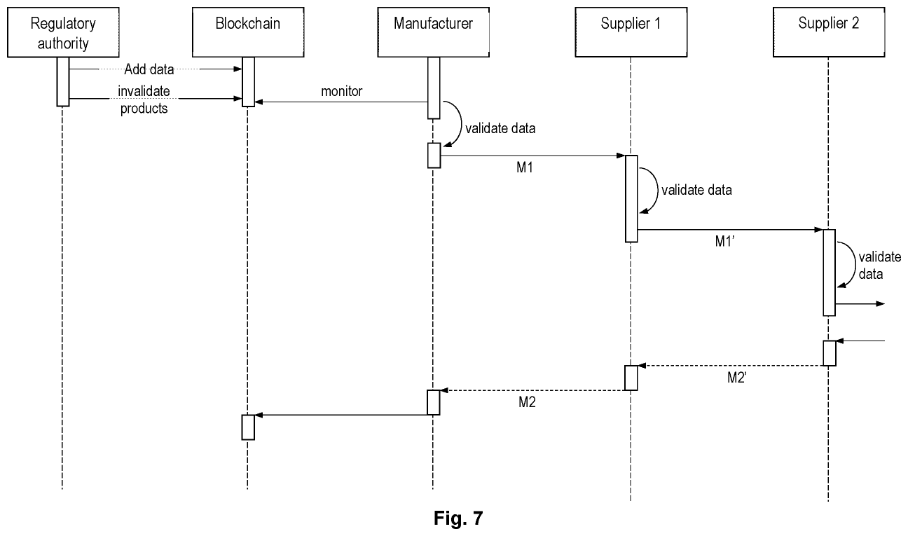

The conditions which are checked or verified here can be arbitrary. A concrete example of this will be described with reference to FIG. 7.

In one embodiment of the invention, the validation query message M1 can contain references to data stored in the server system (in the memory device MD or in the memory device present in the trustworthy and secured environment) and/or references to data stored in the distributed repository network. To process the validation query message M1, the trustlet can read both data from the distributed repository network and data stored in the server system.

The first validation reply message M2 is stored in the repository network and transferred to the client system. It is advantageous here if both the first validation query message M1 and the first validation reply message M2 are stored in encrypted form in the repository network.

In a particular embodiment of the invention, provision can be made for the first validation reply message M2 to be digitally signed by the server or by the trustlet, wherein the signed first validation reply message is stored in the distributed repository network. The signature of the first validation reply message M2 can now be validated in the repository network using a public key of the server or of the trustlet. The server's or trustlet's public key is also stored in the distributed repository network. If the validation is positive, the validation reply message can be transferred to the client system or to the client. The validation can be executed by a validation component VC which is executed in the distributed repository network.

This type of validation of the validation reply message M2 can also be executed by the client itself. That is, the digitally signed first validation reply message is stored in the distributed repository network and transferred to the client. The client then validates the signature of the validation reply message using the public key of the server or trustlet stored in the distributed repository network. If the validation of the signature is positive, the client system or the client can further process the first validation reply message. Otherwise, the first validation reply message can be discarded.

Accordingly, trustworthy data can be stored on the server system, i.e., in the memory device MD of the server system or in the memory device of the trustworthy and secured environment of the server, while untrustworthy data can be stored in the distributed repository network. With the embodiments of the method according to the invention it is thus possible to validate trustworthy data stored on the server system without the data themselves being disclosed or only those data being disclosed which are untrustworthy anyway, since they are stored in the distributed repository network, for example. A corresponding example of this is described in more detail below with reference to FIG. 7.

If the server of the server system cannot answer the validation query message M1 completely independently, it can be provided that the server system generates a second validation query message M1′ based on the first validation query message M1 and transfers this to another server system and stores it in the distributed repository network. The additional server system can then correspondingly generate a second validation reply message M2′ and store it in the distributed repository network and transfer it to the server system. In this case, the server system represents a client system in relation to the other server system. The additional server system can also have a server with a secured and trustworthy environment, in which a trustlet is also executed. In this way, a hierarchical or multi-level validation of trustworthy data can be implemented.

In one embodiment of the invention, it can be advantageous if the trustlet is an interpreter which is adapted to interpret a script and to execute the instructions stored in the script. In this case, a script can be stored in the distributed repository network, for example in the blockchain network, which is loaded into the trustworthy and secured environment of the server system or from the trustworthy and secured environment of the server system and can be executed there from the trustlet configured as an interpreter. This has the advantage that neither the trustlet nor the trustworthy and secured environment of the server system needs to be changed if the logic of the validation of the trustworthy data changes. If the logic of the validation of the trustworthy data changes, only the script, which contains the corresponding validation instructions or regulations, has to be adapted accordingly and loaded into the trustworthy and secured environment of the server system.

FIG. 7 is a flow chart for a multi-level or hierarchical validation of trustworthy data.

The process is described using an example in which a manufacturer of a product, such as a cosmetic product, has to specify certain ingredients on the packaging or on the label. These ingredients, which must be declared, are specified by a regulatory authority. The manufacturer of the cosmetic product uses ingredients known to him for the production and buys certain components of the cosmetic product from a first supplier, wherein the manufacturer does not know the exact composition of these components. The first supplier can in turn buy components from a second supplier, wherein the first supplier does not know the composition of the components obtained from the second supplier.

In order for the manufacturer of the cosmetic product to be able to specify all ingredients which are subject to declaration, the manufacturer of the cosmetic product must query all ingredients which are subject to declaration from all suppliers in the entire supply chain. In the prior art, such a query may take several weeks or even several months, since all suppliers have to be queried manually. In the worst case, the delivery of the manufactured cosmetic products has to be stopped or postponed. In addition, the suppliers have no interest in disclosing the composition of the components supplied. Rather, the suppliers only want to disclose the parts of the components which are subject to declaration.

With embodiments of the method according to the invention for validating trustworthy data, it is possible, on the one hand, for only untrustworthy data (in this example, the ingredients which are subject to declaration) to be disclosed. On the other hand, the entire validation process can be reduced to a few minutes or even a few seconds, effectively preventing delivery delays.

Data on the substances or ingredients regulated by the regulatory authority are stored in the distributed repository network or in the blockchain. All entities involved in the validation process (manufacturers and suppliers) can access the data stored in the blockchain. The regulatory authority also registers products which contain at least one ingredient which must be declared.

As soon as data of a new ingredient subject to declaration are added to the distributed repository network or the data of an ingredient already added to the distributed repository network are changed by the regulatory authority, the data of the products are marked as invalid in the distributed repository network which contains such a new or changed declarable ingredient.

The manufacturer of the cosmetic product monitors the data stored in the distributed repository network. As soon as data relevant to him have changed in the repository network or new data have been added to the repository network, the manufacturer of the cosmetic product can start the validation process for his products. The monitoring of the distributed repository network or the starting of the validation process is accomplished by a client system assigned to the manufacturer.

As soon as the client system assigned to the manufacturer detects a change in the data stored in the distributed repository network, the client system checks which components of the cosmetic product are provided by an external supplier. In the exemplary embodiment shown in FIG. 7, such a component is provided by the supplier 1.

The client system then generates a first validation query message M1 and transfers it to the server system of the first supplier (supplier 1), wherein the first validation query message M1 is also stored in the distributed repository network. The first validation query message M1 contains information about which data are to be validated by the first supplier's server system. In the present case, the first validation query message can comprise information about the fact that a specific component supplied by the first supplier has to be validated, i.e., the ingredients regulated for this component are to be communicated to the manufacturer or the client system.

The server of the first supplier receives the first validation query message M1 and transfers it to the trustlet, which is executed in the secured and trustworthy environment of the server.

The trustlet now analyzes the ingredients of the component to be validated, wherein an ingredient in the present example again is a component which is supplied by the supplier 2 to the supplier 1.

For all ingredients which are not supplied by another supplier, the trustlet of the first supplier's server checks whether they meet predetermined conditions. If an ingredient meets the predetermined condition, this ingredient must be communicated to the manufacturer of the cosmetic product or the client system. A predetermined condition can be, for example, that the ingredient is a regulated ingredient or an ingredient which is subject to declaration. To check whether an ingredient meets such conditions, the trustlet executes a comparison of the data of the ingredients with the data stored in the repository network, wherein the trustlet determines whether data corresponding to the data of an ingredient are stored in the distributed repository network. In this case, the predetermined condition can be regarded as met if data sets corresponding to the data of an ingredient are stored in the repository network.

The trustlet of the server of the first supplier now generates a first validation reply message M2 and adds information about those ingredients which meet the predetermined conditions to this validation reply message. Ingredients which do not meet the predetermined conditions are not added to the validation reply message M2, so that they are not disclosed to the client or the manufacturer of the cosmetic product. The formulation of the component to be validated and queried with the first validation query message M1 therefore does not have to be disclosed and thus remains secret.

Before the validation reply message M2 is transferred to the client system, the server or the trustlet of the server of the first supplier generates a second validation query message M1′ in a corresponding manner for the components which are supplied by the second supplier and transfers this to the server of the second supplier.

The server of the second supplier accepts this second validation query message M1′ and transfers it to the server's trustlet, which is also executed in a secured and trustworthy area of the server. The trustlet of the second supplier's server also checks which ingredients of the queried component meet predetermined conditions, for example are subject to declaration or are regulated. The procedure here is analogous to the trustlet of the server of the first supplier. This means that the trustlet of the second supplier's server checks whether data corresponding to the contents of the component to be validated are stored in the distributed repository network.

The trustlet of the server of the second supplier now generates a second validation reply message M2′ and adds to it information about those ingredients which meet the predetermined conditions. The ingredients which do not meet the predetermined conditions are not added to the validation reply message M2′, i.e., they remain secret.

If the component to be validated by the trustlet of the second supplier does not have any ingredients which are supplied by another supplier, the trustlet transfers the validation reply message M2′ to the server of the first supplier.

In the event that the component to be checked by the trustlet of the second supplier contains components which are supplied by another supplier, these components must be validated by a trustlet of the other supplier, wherein the respective validation is analogous to that of the trustlets of the validations executed by the first and the second supplier.

The first supplier's server receives the second validation reply message M2′ from the second supplier's trustlet. The validation reply message M2′ received from the server is transferred to the server's trustlet. The trustlet of the first supplier's server can now insert the data received with the second validation reply message M2′ into the first validation reply message M2.

The trustlet then transfers the first validation reply message M2 to the cosmetic product manufacturer's client system. The manufacturer of the cosmetic product now has all the information about the ingredients of the cosmetic product which are regulated or subject to declaration and which are contained in the components of the suppliers, so that the manufacturer can display information about these data on the packaging.

The manufacturer's client system now only has to validate the ingredients which are not contained in the components of the suppliers. For this purpose, a trustlet is also executed on the client system in a trustworthy and secured area of the client system. The validation of these ingredients is analogous to the validation which the trustlets execute on the two server systems.

All validation query messages and validation reply messages are stored in the distributed repository network and, if necessary, encrypted and signed.

Finally, the product data stored in the distributed repository network are marked as valid by the client system's trustlet.

With the help of the trustlets, which are executed according to embodiments of the invention, it can therefore be ensured that trustworthy data remain trustworthy even when a workflow is executed in a distributed system.

1. A computer-implemented method for validating trustworthy data in a computer system which comprises
a distributed repository network,
a first client system which is operatively coupled or operatively couplable to the repository network, and
at least one first server system which is operatively coupled or operatively couplable to this repository network,
wherein the trustworthy data comprise data sets which are stored in a memory device of the first server system, wherein
a first validation query message is generated on the first client system, which first validation query message is stored in the repository network and is transferred to the first server system, wherein the first validation query message comprises information about which data are to be validated by the first server system,
the first server system receives the first validation query message and transfers it to a trustworthy software component for response, which is executed in a trustworthy and secured environment of the first server system, wherein the trustworthy software component
reads a number of data sets from the memory device of the first server system based on the first validation query message,
checks for at least one read data set whether this meets predetermined conditions, and
generates a first validation reply message which comprises information about which of the read data sets meet the predetermined condition, and
the first validation reply message is stored in the repository network and transferred to the first client system.

2. The method of claim 1, wherein the computer system further comprises a second client system which is operatively coupled or operatively couplable to the repository network, wherein untrustworthy data are transferred from the second client system to the repository network and stored in the repository network.

3. The method of claim 2, wherein the trustworthy software component, when checking whether a read data set meets the predetermined conditions, executes a comparison of the read data set with the untrustworthy data stored in the repository network, wherein it is determined whether data corresponding to the read data set are stored in the repository network, wherein the predetermined conditions are met if data corresponding to the read data set are stored in the repository network.

4. The method of claim 2, wherein the first client system monitors the repository network and the first validation query message is generated when the untrustworthy data stored in the repository network change.

5. The method of claim 1, wherein the first validation query message and/or the first validation reply message are stored in encrypted form in the repository network.

6. The method of claim 1, wherein the first server system is in turn coupled or couplable to a second server system, wherein the first server system
generates a second validation query message which is stored in the repository network and is transferred to the second server system based on the first validation query message and/or based on the read data sets, and
receives a second validation reply message from the second server system,
wherein the first server system transfers the received second validation reply message to the first client system as part of the first validation reply message, and
wherein a trustworthy software component which is executed in a trustworthy and secured environment of the second server system,
reads a number of data sets from a memory device of the second server system based on the second validation query message,
checks for at least one read data set whether this meets predetermined conditions, and
generates the second validation reply message which comprises information about which of the read data sets meet the predetermined condition.

7. The method of claim 6, wherein the trustworthy software component, when checking whether a read data set meets the predetermined conditions, compares the read data set with untrustworthy data stored in the repository network, wherein it is determined whether data corresponding to the read data set are stored in the repository network, wherein the predetermined conditions are met if data corresponding to the read data set are stored in the repository network.

8. The method of claim 6, wherein the second validation query message and/or the second validation reply message are stored in the repository network in encrypted form.

9. The method of claim 1, wherein the first server system digitally signs the trustworthy software component and wherein the digital signature is stored in the repository network.

10. The method of claim 6, wherein the second server system digitally signs the trustworthy software component and wherein the digital signature is stored in the repository network.

11. The method of claim 1, wherein the first validation reply message is digitally signed by the first server system and wherein in the repository network the signature of the first validation reply message is validated using a public key of the first server system, which is stored in the repository network, wherein the validation reply message is transferred to the first client system if the validation is positive.

12. The method of claim 6, wherein the second validation reply message is digitally signed by the second server system and wherein in the repository network the signature of the second validation reply message is validated using a public key of the second server system, which is stored in the repository network, wherein the second validation reply message is transferred to the first client system if the validation is positive.

13. The method of claim 1, wherein checking whether a read data set meets the predetermined conditions is executed using a predetermined validation logic, wherein information relating to the predetermined validation logic is stored in the repository network.

14. The method of claim 1, wherein the distributed repository network is a blockchain network.

15. The method of claim 1, wherein the trustworthy software component comprises an interpreter adapted to interpret a script and to execute the instructions stored in the script, wherein the instructions comprise validation rules and/or validation instructions.

16. The method of claim 15, wherein the script is stored in the distributed repository network and made available by the trustworthy software component to the software component for interpretation.
